(19) United States
(12) Patent Application Publication
(10) Pub. No.: US 2006/0154131 A1
(43) Pub. Date: Jul. 13, 2006

(54) Fuel cell separator and fabrication method thereof, and conductive corrosion-resistant metallic material

(75) Inventors: Masahiro Seido, Tsuchiura (JP); Mineo Washima, Tsuchiura (JP); Kazuhiko Nakagawa, Niiharigun (JP); Kunihiro Fukuda, Tsukuba (JP); Takaaki Sasaoka, Tsuchiura (JP); Katsumi Nomura, Tsuchiura (JP)

Correspondence Address: FOLEY AND LARDNER LLP;SUITE 500, 3000 K STREET NW, WASHINGTON, DC, 20007, US

(73) Assignee: HITACHI CABLE, LTD.

(21) Appl. No.: 11/319,198

(22) Filed: Dec. 28, 2005

(30) Foreign Application Priority Data
Dec. 28, 2004 (JP) 2004-381883
Oct. 24, 2005 (JP) 2005-308956

(51) Int. Cl. H01M 8/02; B32B 15/01; B32B 15/00

(52) U.S. Cl. 429/34; 428/650; 428/649

(57) ABSTRACT

A fuel cell separator is provided with: a core made of an Al alloy or a Mg alloy; a covering layer made of Ti or a Ti alloy formed on at least one side of the core; and a bonding metal layer formed between the core and the covering layer. The bonding metal layer is made of a metal with a deformation resistance lower than the core and the covering layer.

The present application is based on Japanese patent application Nos. 2004-381883 and 2005-308956, the entire contents of which are incorporated herein by reference.

### BACKGROUND OF THE INVENTION

1. Field of the Invention

This invention relates to a fuel cell separator and a fabrication method thereof, and a conductive corrosion-resistant metallic material. In particular, this invention relates to a fuel cell separator having excellent corrosion resistance and conductivity, and good secondary processability even in a fuel cell environment under electrochemically severe conditions, and a fabrication method of the fuel cell separator, and a conductive corrosion-resistant metallic material.

2. Description of the Related Art

Fuel cells are not only high-efficient because they are capable of directly transforming a chemical change into electrical energy, but are also global environment-friendly because of small amounts of air pollutants (NOₓ, SOₓ, etc.) to be exhausted. As types of these fuel cells, there are polymer electrolyte fuel cells (PEFCs), phosphoric acid fuel cells (PAFCs), molten carbonate fuel cells (MCFCs), solid oxide fuel cells (SOFCs), etc. Among others, polymer electrolyte fuel cells are expected to be widely used as power for automobiles, home, etc. in the future.

FIG. 1 illustrates a schematic structure of a polymer electrolyte fuel cell. This polymer electrolyte fuel cell 200 comprises a plurality of cells connected end to end (vertically in the figure). One cell includes a pair of plate separators 201A and 201B having grooves 202A, 202B, 202C and 202D formed at a predetermined interval on both sides of each separator 201A and 201B, an electrolytic membrane 203 disposed midway between the separators 201A and 201B, an air electrode 204 disposed between the electrolytic membrane 203 and the separator 201B, and a fuel electrode 205 disposed between the electrolytic membrane 203 and the separator 201A.

The separators 201A and 201B are for electrically connecting the air electrode 204 and the fuel electrode 205, and preventing fuel and air (an oxidizer) from being mixed. The grooves 202B and 202D are used as fuel and air passages in the cells connected end to end.

As the electrolytic membrane 203, there is used a polymer electrolytic membrane. The air electrode 204 includes a porous support layer 204a and an air electrode catalysis layer 204b, while the fuel electrode 205 includes a porous support layer 205a and an fuel electrode catalysis layer 205b.

In FIG. 1, air 208 is brought into contact with the air electrode 204, while at the same time, hydrogen gas 207 is brought into contact with the fuel electrode 205 as fuel, which would result in separation of the hydrogen gas 207 into hydrogen ions and electrons on the fuel electrode 205. These hydrogen ions are combined with water to move to the air electrode 204 side in the electrolytic membrane 203, while the electrons move via an external circuit to the air electrode 204 side. In the air electrode 204, oxygen (O₂/2), electrons (2e⁻), and hydrogen ions (2H⁺) react to create water (H₂O)

It is necessary for the fuel cell separators 201A and 201B to have corrosion resistance to reduction and oxidation atmosphere gases, and high electron conductivity. Accordingly, as its raw material, a graphite-based material was used mainly, but a metallic material that has complicated and high-precision processability is used now. A separator is known that comprises a stainless steel (SUS) base with a Ti, Cr, etc. nitride-containing protective film formed on its surface, to have conductivity and corrosion resistance, where the N content of the Ti, Cr, etc. nitride-containing protective film is decreased inward from the surface (See JP-A-2000-353531, for example).

A separator is also known that comprises a conductive contact layer with a thickness of 0.0005-less than 0.01 μm containing noble metals such as Au, Pt, Ru, Pd, etc. formed on a separator base formed of only a corrosion-resistant metallic material, or a composite material having a corrosion-resistant metallic material on the surface of another metallic material, to have conductivity and corrosion resistance (See JP-A-2004-158437, for example).

A metallic separator is also known that comprises a cladding layer formed of any of Mo, Ti, Zr, Ta, Cr, Nb, V and W on both sides of a metallic base of SUS, Al, etc., followed by having a ceramic surface layer carburized, silicided or nitrided by placing the separator in a high-temperature carbon, silicon or nitrogen compound gas atmosphere, to have high conductivity and corrosion resistance (See JP-A-2000-323148, for example).

However, the prior-art separators are not adequate to meet the requirements for a lighter separator. To reduce the weight of separators, although excellent-conductivity and light metals such as Al, Mg, etc. or its alloys have been used as core materials, these materials are insufficient in corrosion resistance so that they tend to dissolve (corrode) under severe conditions such as cell environments, which causes difficulty in direct use thereof.

Here, if pure Al or a low-concentration Al alloy (that has a low concentration of alloy constituents except Al) is used as a core material and Ti is selected as a corrosion-resistant covering material to be brought into direct contact therewith, there is the problem that Ti/Al cladding is extremely difficult to conduct because of a substantial difference in deformation resistance between Ti and Al.

Further, if an Al alloy or a Mg alloy is used as a core material and Ti is selected as a corrosion-resistant covering material to be brought into direct contact therewith, because a brittle compound layer tends to be created at an interface therebetween, there is the problem that it is difficult to fabricate stably a thin cladding material, and to manufacture (mass-produce) long products at a high yield, even though it is possible to make short products (small samples).

Further, when a plate material comprising an Al alloy or a Mg alloy directly cladded with Ti is pressed and molded into a separator, a crack may occur that can be caused by a compound layer created at the interface between the plate material and the Ti cladding layer. Therefore, local separation etc. may occur at joint portion, which harms good molding (or results in insufficient molding).

### SUMMARY OF THE INVENTION

Accordingly, it is an object of the present invention to provide a fuel cell separator, which has excellent corrosion resistance and conductivity, can be reduced in weight, and has good processability, even in a fuel cell environment under electrochemically severe conditions, and a fabrication method of the fuel cell separator, and a conductive corrosion-resistant metallic material, which can be used in the fuel cell separator and the like.

(1) In accordance with one aspect of the invention, a fuel cell separator comprises:

a core comprising an Al alloy or a Mg alloy;

a covering layer comprising Ti or a Ti alloy and formed on at least one side of the core; and

a bonding metal layer formed between the core and the covering layer to bond the core and the covering layer,

wherein the bonding metal layer comprises a metal that has a deformation resistance lower than the core and the covering layer.

In the above invention, the following modifications and changes can be made.

(i) The covering layer to core deformation resistance ratio is in the range of 0.5 to 2.5 as a Vickers hardness (Hv) ratio.

(ii) The bonding metal layer comprises pure Al, or an Al alloy substantially not containing Mg that has a deformation resistance lower than the core and the covering layer.

(iii) The covering layer comprises a conductive protective film formed on the opposite surface to a junction surface bonded to the core.

(iv) The protective film comprises any of a noble metallic nano film, a graphite-based coating, or a nitride film, or a combination of 2 or more thereof.

(v) The core, the covering layer, and the bonding metal layer have a total thickness of 0.05 mm to 2 mm, and the covering layer occupies preferably 5% to 30% of the thickness.

(2) In accordance with another aspect of the invention, a conductive corrosion-resistant metallic material comprises:

a core comprising an Al alloy or a Mg alloy;

a covering layer comprising Ti or a Ti alloy for being disposed on at least one side of the core; and

a bonding metal layer formed between the core and the covering layer to bond the core and the covering layer,

wherein the bonding metal layer comprises a metal that has a deformation resistance lower than the core and the covering layer.

(3) In accordance with yet another aspect of the invention, a method for fabricating a fuel cell separator comprises the steps of:

cladding a covering layer comprising Ti or a Ti alloy, to at least one surface of a core comprising an Al alloy or a Mg alloy, via a bonding metal layer comprising a metal that has a deformation resistance lower than the core and the covering layer; and

forming a conductive protective film on the opposite surface to a junction surface bonded to the core of the covering layer.

(4) In accordance with still yet another aspect of the invention, a method for fabricating a fuel cell separator comprises the steps of:

forming a conductive protective film on one side of a covering layer comprising Ti or a Ti alloy beforehand, and forming a bonding metal layer on the opposite side; and

cladding the covering layer and a core comprising an Al alloy or a Mg alloy, via a bonding metal layer comprising a metal that has a deformation resistance lower than the core and the covering layer.

The cladding step can be performed by rolling or hydrostatic extrusion.

### ADVANTAGES OF THE INVENTION

According to the present invention, it is possible to provide a fuel cell separator, which has excellent corrosion resistance and conductivity, can be reduced in weight, and has good processability, even in a fuel cell environment under electrochemically severe conditions, and a fabrication method of the fuel cell separator, and a conductive corrosion-resistant metallic material, which can be used in the fuel cell separator and the like.

### BRIEF DESCRIPTION OF THE DRAWINGS

The preferred embodiments according to the invention will be explained below referring to the drawings, wherein:

FIG. 1 is an exploded perspective view illustrating a schematic structure of a polymer electrolyte fuel cell;

FIG. 2 is a cross-sectional view illustrating a fuel cell separator according to an embodiment of the invention;

FIG. 3 is a diagram showing the steps of a fabrication process of a fuel cell separator according to an embodiment of the invention;

FIG. 4A is an explanatory diagram showing defects caused during cladding rolling;

FIG. 4B is an explanatory diagram showing proper cladding rolling; and

FIG. 5 is a diagram showing the steps of a fabrication process of a fuel cell separator according to a different embodiment of the invention from FIG. 3.

### DETAILED DESCRIPTION OF THE PREFERRED EMBODIMENTS

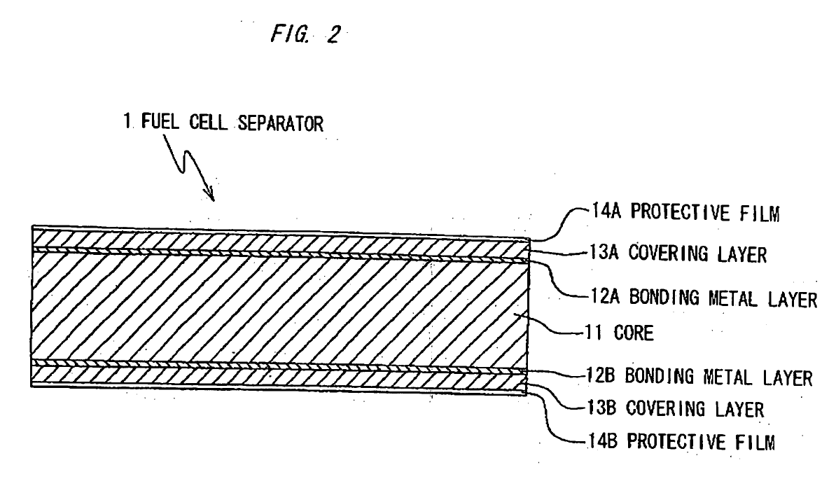

FIG. 2 illustrates a fuel cell separator according to a preferred embodiment of the invention. This fuel cell separator 1 comprises a plate core 11 formed of a light metal material with smaller deformation resistance than that of Ti material where the deformation resistance represents resistive force against plastic deformation, a pair of bonding metal layers 12A and 12B formed on both sides, respectively, of the core 11, a pair of covering layers 13A and 13B formed on the surfaces of the bonding metal layers 12A and 12B, respectively, and protective films 14A and 14B formed on the surfaces of the covering layers 13A and 13B, respectively.

As the core 11, there may be used a light metal such as an Al alloy or a Mg alloy, or preferably an Al—Mg alloy, whose deformation resistance is smaller than that of Ti material (the covering layers 13A and 13B) where the deformation resistance represents resistive force against plastic deformation. The alloy may contain Cr, Mn, etc. and there can specifically be shown 4.4Mg—0.7Mn—0.15Cr—the remaining Al, as one example.

The core 11 has a hardening property as well as the plastic property. The covering layers 13A and 13B also tend to be hardened. Accordingly, if the value for the deformation resistance of the core 11 is close to that of the covering layers 13A and 13B, the hardness increases in a well-balanced manner. As the ratio of the covering layers 13A and 13B to core 11 deformation resistance is closer to 1, the processability is better, and the deformation resistance ratio ranges desirably 0.5 to 2.5. More desirably, the deformation resistance ratio ranges 0.7 to 2.0. Still more desirably, the deformation resistance ratio ranges 0.8 to 1.5. The deformation resistance ratio can be obtained as a Vickers hardness (Hv) ratio.

As the bonding metal layers 12A and 12B, there may be used a metal having lower deformation resistance than that of the core 11 and the covering layers 13A and 13B. A metal, such as pure Al, or an Al alloy substantially not containing Mg may preferably be used as the bonding metal layers 12A and 12B so as not to form (so as to inhibit formation of) a brittle compound layer at an interface during cladding which detrimentally affects the processing, (for example, Ti—Mg compounds, and Mg oxides, which substantially degrade ductility of the cladding material, and which are considered to be created (formed) by diffusion of Mg from the underlying layer (core 11)). Here, the term “substantially not containing Mg” refers to the range of the Mg content in which the amount of the above-mentioned brittle compound layer formed is negligibly small (does not detrimentally affect the processing. That is, for the bonding metal layers 12A and 12B, a metal may preferably be used, provided that it has lower deformation resistance than that of the core 11 and the covering layers 13A and 13B, and serves to inhibit formation of a brittle compound layer.

As the covering layers 13A and 13B, there may be used Ti or a Ti alloy that has excellent conductivity and corrosion resistance. The covering layers 13A and 13B form a cladding layer. The entire thickness of the core 11 and the cladding layer is 0.05-2 mm, wherein the covering layers 13A and 13B are formed in such a manner as to occupy 5-30% of the thickness.

The protective films 14A and 14B are nano metallic conducting films provided for preventing oxidation (ensuring conductivity) of the covering layers 13A and 13B. The protective films 14A and 14B may be any of noble metallic nano films, graphite-based coatings, or nitride films, or a combination of 2 or more thereof.

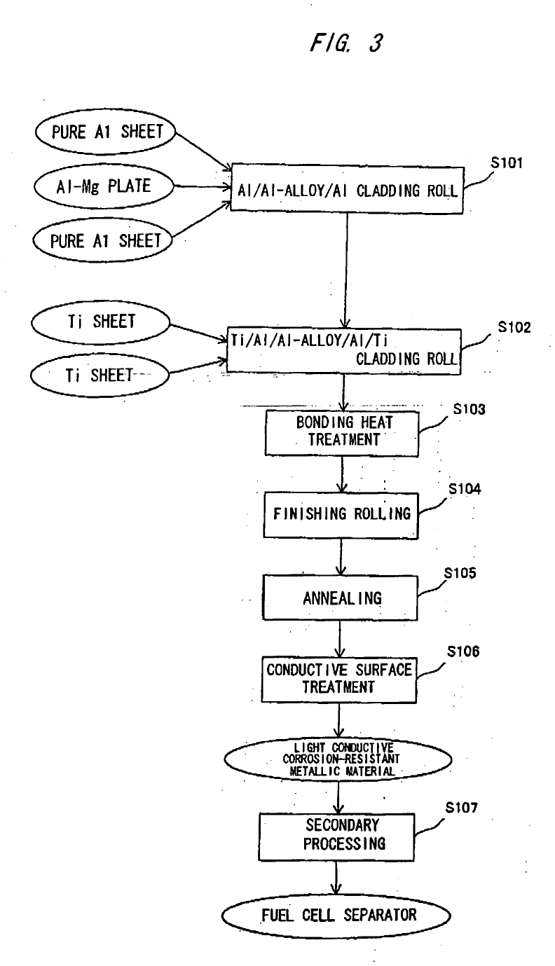

Next, the fabrication method of a fuel cell separator according to a preferred embodiment of the invention will be explained. FIG. 3 shows one example of the steps of a fabrication process of a fuel cell separator according to a preferred embodiment of the invention. In the same figure, the “S” represents a step.

First, a pure Al sheet is cladded and rolled on the upper and lower surfaces of an Al or Mg alloy plate, or preferably an Al—Mg alloy plate that serves as a core 11, to form a cladding plate of Al/Al—Mg alloy (Al alloy, Mg alloy)/Al as bonding metal layers 12A and 12B (S101).

Next, a Ti corrosion-resistant metallic sheet is cladded and rolled on the upper and lower surfaces of the cladding plate as covering layers 13A and 13B, to form a 5-layer cladding plate of Ti/Al/Al—Mg alloy (Al alloy, Mg alloy)/Al/Ti (S102).

The cladding may be formed by plastic processing such as hydrostatic extrusion, as well as rolling. Here, the term “cladding by plastic processing” refers to integration by cladding, and to integration of the core 11 and the covering layers 13A and 13B via the bonding metal layers 12A and 12B in this embodiment.

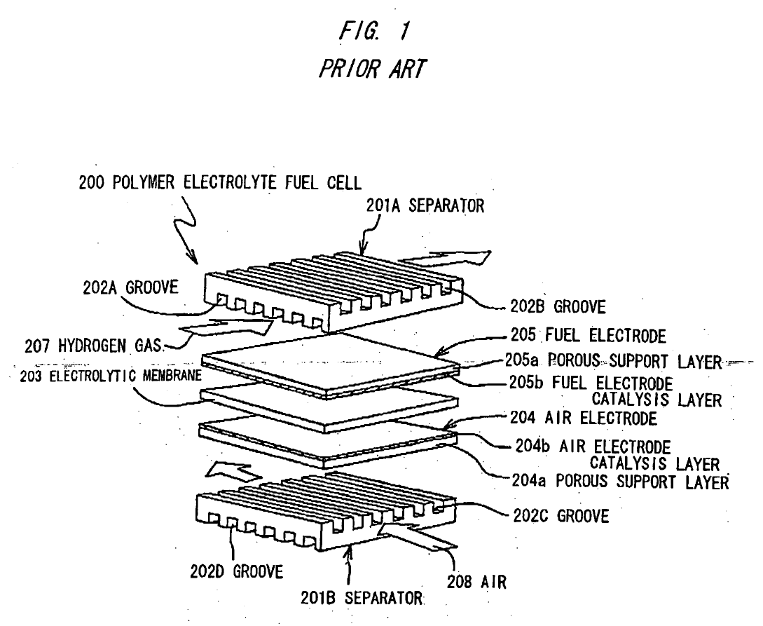

This is followed sequentially by bonding heat treatment (S103), finishing rolling (S104), annealing (S105), and conductive surface treatment (protective film 14A and 14B formation) (S106), to thereby complete a plate of light conductive corrosion-resistant metallic material that can be used as a fuel cell separator 1. Secondary processing such as pressing is performed to this light conductive corrosion-resistant metallic material (S107), to thereby obtain separators 201A and 201B that can be used as a fuel cell, as shown in FIG. 1.

The reason for performing bonding heat treatment (S103) is because it enhances chemical bonding (chiefly, metallic bond) between constituent metal atoms in the cladding layer interface, and therefore the bonding state between the layers. Also, annealing (S105) has the effect of enhancing ductility of the cladding material. Annealing (S105) is performed appropriately according to degree of hardening.

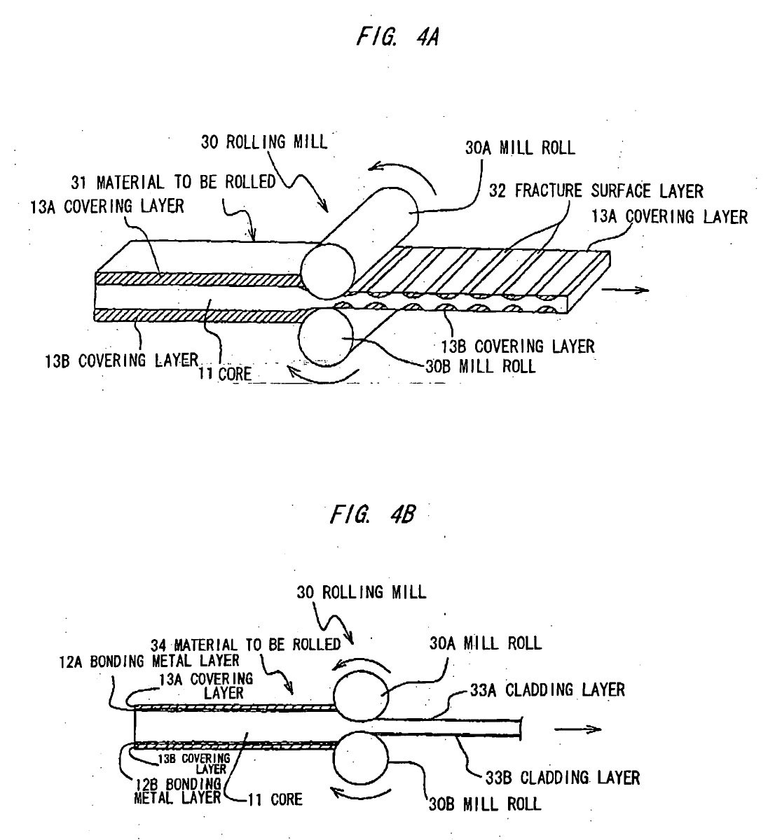

FIG. 4A is an explanatory diagram showing defects caused during cladding rolling, and FIG. 4B is an explanatory diagram showing proper cladding rolling. In FIGS. 4A and 4B, a rolling mill 30 comprises a pair of mill rolls 30A and 30B arranged on upper and lower sides. A material 31 to be rolled that comprises the core 11 and the covering layers 13A and 13B is inserted between and passed through the pair of mill rolls 30A and 30B for cladding rolling.

FIG. 4A is a comparison example, in which the material 31 to be rolled is covered with only the covering layers 13A and 13B, but not with bonding metal layers 12A and 12B. On the other hand, FIG. 4B corresponds to the fuel cell separator 1 having the structure shown in FIG. 2, in which a material 34 to be rolled comprises a core 11, and cladding layers 33A and 33B consisting of bonding metal layers 12A and 12B and covering layers 13A and 13B formed on both sides, respectively, of the core 11. In both FIGS. 4A and 4B, rolling is performed without forming protective films 14A and 14B.

The phenomenon indicated in FIG. 4A shows defects caused during rolling, i.e., surface layer fractures 32 due to development of defects (abnormal deformation) called ripples. The “ripples” refer to abnormal undulations of a surface layer interface (a junction interface) of a composite material (the material 31 to be rolled in FIG. 4A). In the material 34 to be rolled depicted in FIG. 4B, on the other hand, proper rolling is performed, which results in no ripples and no surface layer fractures.

Ripples tend to occur when no bonding metal layers 12A and 12B are provided, which substantially narrows the range of conditions of sound processing. Accordingly, the bonding metal layers 12A and 12B are the essential constituent elements.

Such ripples may not only occur in the first cladding rolling, but also in the subsequent rolling steps. Even in such a case, the effect of the bonding metal layers is significant.

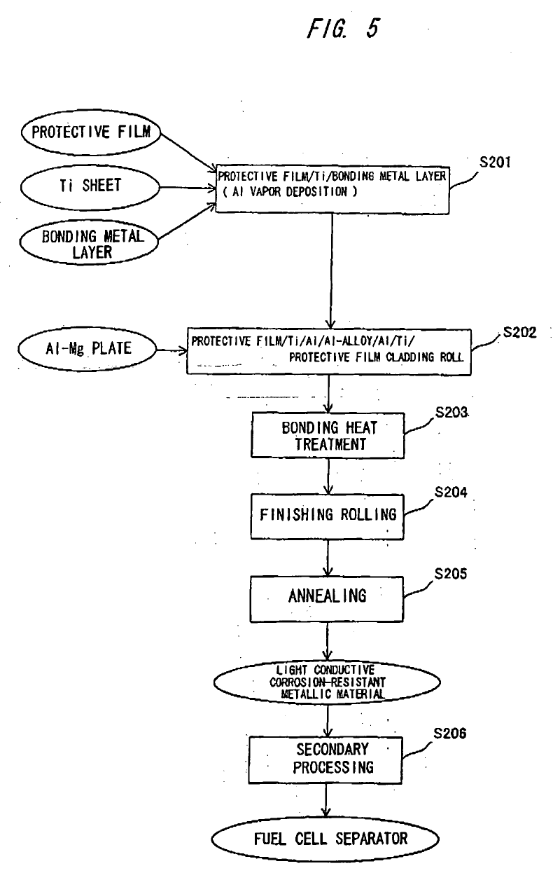

FIG. 5 is a diagram showing the steps of a fabrication process of a fuel cell separator according to a different embodiment of the invention from FIG. 3. In the same figure, the “S” represents a step.

First, using vapor deposition, conductive protective films 14A and 14B are formed beforehand on one side of a Ti or Ti-alloy sheet that serves as covering layers 13A and 13B, and pure Al bonding metal layers 12A and 12B (e.g., with a thickness of the order of 0.05-1 μm) on the opposite side (S201).

Next, the covering layers 13A and 13B formed in S201 and an Al or Mg alloy plate, or preferably an Al—Mg alloy plate that serves as a core 11 are cladded and rolled via the bonding metal layers 12A and 12B, to form a 7-layer cladding plate of protective film/Ti/Al/Al—Mg alloy (Al alloy, Mg alloy)/Al/Ti/protective film as covering layers 13A and 13B (S202).

This is followed sequentially by bonding heat treatment (S203), finishing rolling (S204), and annealing (S205), to thereby complete a plate of light conductive corrosion-resistant metallic material that can be used as a fuel cell separator 1. Secondary processing such as pressing is performed to this light conductive corrosion-resistant metallic material (S206), to thereby obtain separators 201A and 201B that can be used as a fuel cell, as shown in FIG. 1. Annealing (S205) is performed appropriately according to degree of hardening.

This embodiment can offer the following advantages:

(a) Because of an Al or Mg alloy used as the core 11 that has a less difference in deformation resistance between it and the covering layers 13A and 13B, the specified bonding metal layers 12A and 12B provided between the core 11 and the covering layers 13A and 13B, and the protective films 14A and 14B provided on the surfaces of the covering layers 13A and 13B respectively, it is possible to obtain a fuel cell separator, which is excellent in corrosion resistance and conductivity, and light in weight, and has good processability.

(b) Because of the bonding metal layers 12A and 12B, such as pure Al, or an Al alloy substantially not containing Mg arranged between the core 11 and the covering layers 13A and 13B, which have lower deformation resistance than that of the core 11 and the covering layers 13A and 13B, to inhibit formation of a brittle compound layer which detrimentally affects the processing, it is possible to obtain a fuel cell separator, which is thin and light, and has good processability. For example, in comparison with a prior-art SUS-based separator, in the case of the same size, mass can be reduced to about ½.

(c) Because of reduced weight, optimal utilization is made as separators for polymer electrolyte fuel cells (PEFCs), or direct methanol fuel cells (DMFCs), which makes it possible to expect reductions in size and weight of power supplies such as mobile and stationary fuel cells.

(d) According to the fabrication method of the embodiment, the soundness of processing finish is good, and it is possible to obtain a fuel cell separator which has no problem with separator properties. In particular, since the fabrication method shown in FIG. 5 allows both the conductive surface films (protective films) and the bonding metal layers to be formed continuously by vapor deposition when the conductive surface films (protective films) are formed by vapor deposition, it is possible to fabricate efficiently a high-quality and high-performance separator.

The present invention is not limited to the above embodiments, but various modifications are possible within the scope not altering the gist of the invention. For example, although the cladding is provided on both sides of the core 11 in the above embodiments, processing may be applied to one side only according to uses, use environments, etc. In some cases, one side of the core 11 may be exposed.

Also, although cold cladding rolling has been explained as the cladding layer formation (processing) method, cladding may be formed by warm or hot rolling, vacuum rolling, or plastic processing such as hydrostatic extrusion.

Further, the light conductive corrosion-resistant metallic material obtained by the above embodiments is not limited to use for fuel cell separators, but it may also be used as materials for components that require conductivity and corrosion resistance in electrical conductive materials, electrical contact materials, electromagnetic shields, electrochemical electrodes, antistatic materials, etc. Particularly, under severe conditions of corrosion resistant environments, it can be optimally used as materials for components that require conductivity. Particularly, use is possible under clean environments where metal ions should not dissolve outside a management system, and specifically optimal application is made to separators for polymer electrolyte fuel cells, methanol fuel cells, etc.

Next, embodiments of the invention will be explained.

### EMBODIMENTS 1-6, AND COMPARISON EXAMPLES 1 AND 2

Using constituent materials shown in Tables 1-4, light conductive corrosion-resistant metallic materials are fabricated that can be used for fuel cell separators, according to the fabrication method of the present preferred embodiment shown in FIG. 3. Tables 2-4 show component compositions of constituent materials (Al alloy or Mg alloy and Ti materials) used, respectively. Ti materials (3 kinds of T-1 to T-3) are used as covering layers, pure Al and Al alloy materials (5 kinds of A-1 to A-5) and a Mg alloy material (M-1) as cores, and pure Al (A-1) as bonding metal layers.

First, as starting materials, 1 mm-thick core materials are prepared, the bonding metal layers and covering layers are cladded, rolled and bonded thereto so that thickness ratio of the constituent materials is 20% (covering layer): 5% (bonding metal layer) : 75% (core). In the case of pure Al or Al alloy core materials, they are cold-cladded (cold-bonded) with Ti material via the bonding metal layer. In the case of Mg alloy core materials, they are warm-cladded (warm-bonded) therewith. This is followed by bonding heat treatment, finishing rolling for processing into 0.3 mm(0.3 mm^{t})—entire thick plate materials (the superscript “t” in “mm^{t}” represents plate thickness), and conductive surface treatment (noble metallic nano film formation), to fabricate light conductive corrosion-resistant metallic materials.

This is followed by measurement of deformation resistance ratios (hardness ratios), and evaluation of soundness of processing, and presence/absence of metal ions of the core materials dissolved. The results are shown in Table 1.

The ratios of the covering layer to core deformation resistance are measured as Vickers hardness (Hv) ratios at room temperature (RT) of softening material (O material).

The soundness of processing is evaluated for defects and ductility: No defect and good ductility are denoted by “G”, the occurrence of minor ripples by “F”, and the occurrence of surface layer fractures (severe ripples) by “P”. The presence/absence of ripples is determined and verified by (visual) observation using an optical microscope at a cross-section perpendicular to a longitudinal direction (rolling direction) of a rolled plate material.

The test for presence/absence of metal ions of the core materials dissolved is performed as follows: A sample buried in an epoxy resin excluding a portion of the surface of the 0.3 mm^{t} plate material (whose end face is protected by a covering) is immersed in a sulfuric solution (pH2, 80° C.) for 100 hrs, followed by measurement of metal ions in the solution by ICP-AES (inductively coupled plasma-atomic emission spectroscopy). No detection of metal ions of the core materials is denoted by “G” and the detection thereof by “P”.

TABLE 1
Evaluation results of light conductive corrosion-resistance metallic materials
whose constituent metallic materials are altered

| Comparison | Comparison | Embodiment | Embodiment | Embodiment | Embodiment | Embodiment | Embodiment |
|---|---|---|---|---|---|---|---|
| Example 1 | Example 2 | 1 | 2 | 3 | 4 | 5 | 6 |

| | | | | |
|---|---|---|---|---|
| Constituent | Covering | Ti(T-1) | Ti(T-2) | Ti(T-3) |
| material | layer | | | |

| Bonding | Pure Al (A-1) | | | | | | |
|---|---|---|---|---|---|---|---|
| metal | | | | | | | |
| layer | | | | | | | |
| Core | Pure Al | Al—Mn alloy | Al—Mg alloy | Al—Mg alloy | Al—Cu alloy | Mg alloy | Al—Mg alloy (A-4) |
| | (A-1) | (A-2) | (A-3) | (A-4) | (A-5) | (M-I) | |

| | | | | | | | | |
|---|---|---|---|---|---|---|---|---|
| Hv hardness ratio | 3.5 | 2.8 | 1.1 | 1.1 | 0.9 | 1.1 | 1.3 | 1.3 |
| (O material, RT) | | | | | | | | |
| Soundness of processing | P | P | G | G | G | G | G | G |
| (0.3 mm^{t} material) | | | | | | | | |
| Presence/absence of | P | P | G | G | G | G | G | G |
| metal ions of core | | | | | | | | |
| material dissolved | | | | | | | | |

TABLE 2
Core (Al alloy material) component composition

| | | | | | | | | | | Kind of | |
|---|---|---|---|---|---|---|---|---|---|---|---|
| Alloy | Al alloy material component composition (unit: mass %) | | | | | | | | | material | |
| No. | Si | Fe | Cu | Mn | Mg | Cr | Zn | Ti | Al | (JIS) | Classification |
| A-1 | 0.15 | 0.31 | 0.02 | 0.01 | 0.01 | N *1 | N *1 | 0.01 | R *2 | 1050 | Pure Al |
| A-2 | 0.6 | 0.7 | 0.1 | 1.3 | N *1 | N *1 | 0.1 | N *1 | R *2 | 3003 | Al—Mn alloy |
| A-3 | 0.15 | 0.3 | 0.01 | 0.7 | 4.4 | 0.15 | 0.05 | 0.05 | R *2 | 5083 | Al—Mg alloy |
| A-4 | 0.2 | 0.35 | 0.15 | 0.3 | 4.6 | 0.1 | 0.05 | 0.1 | R *2 | 5182 | Al—Mg alloy |
| A-5 | 0.5 | 0.5 | 4.2 | 0.6 | 1.5 | 0.1 | 0.25 | N *1 | R *2 | 2024 | Al—Cu alloy |

*1 “N” denotes “no evaluation”.
*2 “R” denotes “the remainder”.

TABLE 3
Core (Mg alloy material) component composition

| | | | | | | | | | | Kind of |
|---|---|---|---|---|---|---|---|---|---|---|
| Alloy | Mg alloy material component composition (unit: mass %) | | | | | | | | | material |
| No. | Al | Mn | Zn | Ca | Si | Cu | Ni | Fe | Mg | (JIS) |
| M-1 | 3.0 | 0.15 | 0.9 | 0.02 | 0.2 | 0.03 | 0.004 | 0.003 | R *1 | AZ31 |

*1 “R” denotes “the remainder”.

TABLE 4
Covering layer (Ti material) component composition

| | | | | | | | | Kind of |
|---|---|---|---|---|---|---|---|---|
| Alloy | Ti material component composition (unit: mass %) | | | | | | | material |
| No. | N | C | H | Fe | O | Pd | Ti | (JIS) |
| T-1 | 0.01 | 0.06 | 0.008 | 0.15 | 0.08 | N *1 | R *2 | 1st kind |
| T-2 | 0.02 | 0.06 | 0.008 | 0.22 | 0.17 | N *1 | R *2 | 2nd kind |
| T-3 | 0.02 | 0.06 | 0.009 | 0.15 | 0.12 | 0.2 | R *2 | 11th kind |

*1 “N” denotes “no evaluation”.
*2 “R” denotes “the remainder”.

As shown in Table 1, when pure Al material (A-1) (comparison example 1) and Al—Mn alloy material (A-2) (comparison example 2) both having a large hardness ratio are used as the core, cladding rolling and subsequent finishing rolling cannot be done smoothly, causing ripples and surface layer cracks (surface layer fractures). On the other hand, when Al—Mg alloy materials (A-3, A-4), Al—Cu alloy material (A-5) and Mg alloy material (M-1) (embodiments 1-6) are used as the core, the hardness ratio is close to 1, which results in no problem with processability (soundness of processing).

Also, in comparison examples 1 and 2 causing ripples and surface layer cracks (surface layer fractures), metal ions (Al ions) of the core materials are detected, but no detection thereof in embodiments 1-6. This shows that the soundness of processing strongly affects corrosion resistance.

Also, although 3 kinds of T-1, T-2 and T-3 are used as the covering layer, there is no particular problem caused, in properties, in processing. A combination of a Ti material and an Al—Mg alloy or Mg alloy material is effective as corrosion resistant metallic materials for fuel cells.

### EMBODIMENTS 7-10, AND COMPARISON EXAMPLES 3-7

Using constituent materials and constituent ratios shown in Table 5, light conductive corrosion-resistant metallic materials are fabricated that can be used for fuel cell separators, according to the fabrication method of the present preferred embodiment shown in FIG. 3. In Table 5, the component compositions of T-1 and A-1 to A-4 are respectively the same as those shown in Tables 2 and 4 above.

Soundness of processing, high/low material cost, and long-term cell properties (1000 hrs, tests for separator corrosion resistance and durability) are evaluated. The results are shown in Table 5.

The soundness of processing is evaluated for defects and ductility: No defect and good ductility are denoted by “G”, the occurrence of minor ripples by “F”, and the occurrence of surface layer fractures (severe ripples) by “P”. The presence/absence of ripples is determined and verified by (visual) observation using an optical microscope at a cross-section perpendicular to a longitudinal direction (rolling direction) of a rolled plate material.

The low material cost (⅓ or less of Ti material cost) and high material cost (higher than ⅓ of Ti material cost) are denoted by “G” and “P”, respectively. Also, the “N” in the table denotes “no evaluation”.

The long-term cell property test (1000 hrs) is performed as follows: Secondary processing (pressing) is performed to light conductive corrosion-resistant metallic materials fabricated, to fabricate polymer electrolyte fuel cell separators. Thereafter, the polymer electrolyte fuel cell separators are combined with an MEA (a membrane electrode assembly) prepared separately, to thereby make fuel cells, to which power generation tests are performed. The MEA is made by applying (fuel electrode and air electrode) catalyses (TEC10V50E made by Tanaka Kikinzoku Kogyo Co., Ltd) dispersed in a solution (Nafion 5% solution, Sigma Aldridge Japan, Corporation), to an electrolytic membrane (Nafion® 112, DuPont Corporation) for hot-press bonding. In this case, the thickness to be applied is adjusted so that the amount of platinum is 0.4 mg/cm² on both the fuel electrode and air electrode sides. Also, the conditions of the power generation test are as follows: The fuel (hydrogen gas) availability is 70%. The oxidizer (oxygen-in-air) availability is 40%. Current flow is constant (current density=0.25 A/cm²). The results of the power generation tests are shown by “G” and “P”, where the “G” denotes stable cell properties without deterioration observed, (i.e., the decreasing rate of output voltage: 10 mV/kh or less), and the “P” denotes deteriorating cell properties observed, (i.e., the decreasing rate of output voltage: more than 10 mV/kh).

TABLE 5
Constituent materials and constituent ratios and evaluation results thereof

| | | Embodi- | Embodi- | Comparison | Comparison | Embodiment | Embodiment | Comparison | Comparison | Comparison |
|---|---|---|---|---|---|---|---|---|---|---|
| | | ment 7 | ment 8 | example 3 | example 4 | 9 | 10 | example 5 | example 6 | example 7 |
| Constituent | Covering | Ti(T-1) | | | | Ti(T-1) | | | Ti(T-1) | |
| material | layer | | | | | | | | | |
| | Bonding | Pure Al (A-1)- | | | | Al—Mn alloy (A-2) | | | None | |
| | metal | | | | | | | | | |
| | layer | | | | | | | | | |
| | Core | Al—Mg alloy (A-3) | | | | Al—Mg alloy (A-4) | | | Al—Mg alloy (A-3) | |
| Constituent | Covering | 20% | 5% | 3% | 40% | 20% | 5% | 3% | 25% | 8% |
| ratio | layer | | | | | | | | | |
| | Bonding | 5% | 3% | 3% | 5% | 5% | 3% | 3% | 0% | 0% |
| | metal | | | | | | | | | |
| | layer | | | | | | | | | |
| | Core | 75% | 92% | 94% | 55% | 75% | 92% | 94% | 75% | 92% |
| Soundness | 0.5 mm^{t} | G | G | P | G | G | G | G | F | P |
| of | 0.2 mm^{t} | G | G | P | G | G | G | P | P | P |
| processing | 0.1 mm^{t} | G | F | P | G | G | G | P | P | P |
| | 0.06 mm^{t} | G | F | P | G | G | F | P | P | P |
| | 0.05 mm^{t} | G | F | P | G | G | F | P | P | P |

| | | | | | | | | | |
|---|---|---|---|---|---|---|---|---|---|
| Cost | G | G | N | P | G | G | N | N | N |
| Long-term cell properties | G | G | N | N | G | G | N | N | N |
| (1000 hrs) | | | | | | | | | |

From Table 5, it is found that in the case of no bonding metal layers, no sound product is obtained in thin materials (of 0.5 mm^{t} or less). (The superscript “t” in “mm^{t}” represents plate thickness.) Also, when pure Al and Al—Mg alloys are used as the bonding metal layers, it is possible to reduce thickness to 0.5 mm^{t} to 0.05 mm^{t}. Also, sound products can be obtained at 5% ormoreof the Ti constituent ratio (thickness) of the covering layers. At 30% or more of the Ti constituent ratio (thickness), cost is considered disadvantageous because Ti is costly.

Also, the tests for long-term cell properties of embodiments 7-10 have verified that even in 1000 hr power generation, because of stable cell properties without deterioration observed, a fuel cell separator (a light conductive corrosion-resistant metallic material) according to the present invention has excellent corrosion resistance and durability, and good processability (i.e., no defects caused by secondary processing (pressing)), even in a fuel cell environment under electrochemically severe conditions.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A fuel cell separator, comprising:
a core comprising an Al alloy or a Mg alloy;
a covering layer comprising Ti or a Ti alloy and formed on at least one side of the core; and
a bonding metal layer formed between the core and the covering layer to bond the core and the covering layer,
wherein the bonding metal layer comprises a metal that has a deformation resistance lower than the core and the covering layer.

2. The fuel cell separator according to claim 1, wherein:
the covering layer to core deformation resistance ratio is in the range of 0.5 to 2.5 as a Vickers hardness (Hv) ratio.

3. The fuel cell separator according to claim 1, wherein:
the bonding metal layer comprises pure Al, or an Al alloy substantially not containing Mg that has a deformation resistance lower than the core and the covering layer.

4. The fuel cell separator according to claim 1, wherein:
the covering layer comprises a conductive protective film formed on the opposite surface to a junction surface bonded to the core.

5. The fuel cell separator according to claim 4, wherein:
the protective film comprises any of a noble metallic nano film, a graphite-based coating, or a nitride film, or a combination of 2 or more thereof.

6. The fuel cell separator according to claim 1, wherein:
the core, the covering layer, and the bonding metal layer have a total thickness of 0.05 mm to 2 mm; and
the covering layer occupies 5% to 30% of the thickness.

7. A conductive corrosion-resistant metallic material, comprising:
a core comprising an Al alloy or a Mg alloy;
a covering layer comprising Ti or a Ti alloy for being disposed on at least one side of the core; and
a bonding metal layer formed between the core and the covering layer to bond the core and the covering layer,
wherein the bonding metal layer comprises a metal that has a deformation resistance lower than the core and the covering layer.

8. A method for fabricating a fuel cell separator, comprising the steps of:
cladding a covering layer comprising Ti or a Ti alloy, to at least one surface of a core comprising an Al alloy or a Mg alloy, via a bonding metal layer comprising a metal that has a deformation resistance lower than the core and the covering layer; and
forming a conductive protective film on the opposite surface to a junction surface bonded to the core of the covering layer.

9. A method for fabricating a fuel cell separator, comprising the steps of:
forming a conductive protective film on one side of a covering layer comprising Ti or a Ti alloy beforehand, and forming a bonding metal layer on the opposite side; and
cladding the covering layer and a core comprising an Al alloy or a Mg alloy, via a bonding metal layer comprising a metal that has a deformation resistance lower than the core and the covering layer.

10. The method according to claim 8, wherein:
the cladding step is performed by rolling or hydrostatic extrusion.

11. The method according to claim 9, wherein:
the cladding step is performed by rolling or hydrostatic extrusion.
